(19) United States
(12) Patent Application Publication
(10) Pub. No.: US 2008/0255971 A1
(43) Pub. Date: Oct. 16, 2008

(54) METHOD AND SYSTEM OF SELF-AUDITING FOR RECOVERING SALES TAX

(75) Inventors: Christopher McKinnon, Toronto (CA); Edward Hajdasz, Mississauga (CA)

Correspondence Address: NELLIGAN O'BRIEN PAYNE LLP, 66 SLATER, SUITE 1900, OTTAWA, ON, K1P-5H1, CA

(73) Assignee: EPIPHANY STAR LTD., Toronto (CA)

(21) Appl. No.: 11/733,244

(22) Filed: Apr. 10, 2007

(51) Int. Cl. G06F 19/00

(52) U.S. Cl. 705/31

(57) ABSTRACT

This invention relates to a method and system of self-auditing for recovering refundable sales taxes, including but not limited to value-added (VAT), by performing specifically established tax compliance algorithmic functions. Business entities are entitled to recover tax paid on purchased goods and services. The method and system allow the business to conduct self-audit on their own accounting system, which contains its business related accounts payable accounting transaction data in order to extract specific data anomalies related to sales tax entitlements. The method and system process and identify specific transaction details and calculate differential monetary currency tax recovery amounts that have been overlooked as tax entitlements or overpaid in error to vendors for their determination of their net tax owing to various government bodies.

### FIELD OF THE INVENTION

The present invention relates to a method and system for auditing sales tax, more particularly to a method and system for recovering refundable sales taxes, including but not limited to value-added tax (VAT).

### BACKGROUND OF THE INVENTION

Business entities are entitled to recover sales tax paid on purchased goods and services, in general. As well, overpaid taxes have been neglected by many of the business entities for various reasons.

For example, sales taxes or commodity taxes need to be defined and paid by business enterprises in the course of their commercial operations. Proper and efficient fulfillment of these requirements by the business enterprise is subject to different effective tax rates by different levels of governmental jurisdictions within a country. These varying tax rates applicable to goods and services are governed by the nature and purpose of the purchased, leased or other such nature of the goods and services.

Under multi-stage sales tax systems, these business enterprises pay sales tax to their vendors, collect on their sales, and forward the net difference to the government. Therefore, the business entities are entitled to recover these sales taxes/value-added tax (VAT) they pay or are charged by vendors on purchases by accumulating their tax credit entitlements. The business enterprises record their sales tax paid or accrued to vendors in related accounting systems, which are accumulated by the business enterprises into various accounts payable journals and other related accounting type journals, and, thus, the accumulation of the tax paid into accounting records is summarized and used as a basis for calculating net tax payable to government entities. However, due to lack of knowledge or internal review, the business entities would, often, under-claim (in whole or in part) the accumulation of the entitled tax credits or refunds for purposes of calculating net tax payable or net tax refundable.

It is also true that, under single-stage sales tax systems, the business enterprises pay tax in error to vendors where they may otherwise be entitled to purchase goods or services without the payment of tax. It is to be noted that where tax was erroneously charged by vendors to the business enterprises or paid in error by the business entities, tax is subject to refund or adjustment either from the vendor or the applicable government jurisdiction. In both multi and single-stage tax systems, it is also to be noted that effective sales tax rates respective to these goods and services can, at times, be different since the jurisdictions may either define the rates only for a certain limited time, or, in the normal course of rate setting, change the rate.

In conventional sales tax industry practice, there are other businesses or individuals, whose stated purpose is to consult or to act as agents for some business entities in order to reconcile, recover or identify on their behalves, such taxes that may be sales taxes, commodity taxes, value-added taxes or other consumption taxes, for a monetary fee for service to identify recoverable taxes. However, the qualities of services that the business entities receive varies among the agents, and the services themselves are, often, very costly. Also, for such monetary practical and security reasons, many of the business entities wish not to involve such agents but to conduct such reviews internally if they are able to do so.

### SUMMARY OF THE INVENTION

The present invention relates to a method and system for auditing sales tax, more particularly to a method and system for recovering refundable sales taxes, including but not limited to value-added tax (VAT).

One objective of the present invention is to provide a method, tools, and system for recovering sales taxes, commodity taxes, value added taxes, and/or other consumption taxes, without involving external agents, but rather enables a company employee user to conduct such audit internally.

According to one aspect of the invention, it provides a computerized method of self-auditing for recovering sales taxes, comprising the steps of: (i) receiving scope and size of audit from a user; (ii) retrieving vendor information and accounts payable data from at least one data storage according to the scope and the size of the audit for creating a vendor master data file and an accounts payable data file; (iii) receiving, from the user, information on required fields in the vendor master data file and the accounts payable data file for generating a cleansed vendor master data file and a cleansed accounts payable data file; (iv) combining the cleansed vendor master data file and the cleansed account payable data file for generating a combined list, wherein the combined list comprises at least one invoice; (v) analyzing tax amounts and at least one invoice amount of each of said at least one invoice in the combined list to determine any error in recording said each of said at least one invoice for generating an initial exception list; (vi) providing the initial exception list to the user and receiving input from the user for generating a final exception list; and (vii) generating from the final exception list a plurality of tax reports for recovering sales taxes.

According to another aspect of the present invention, it provides a self-audit system for recovering sales taxes, comprising: (i) a computing device; and (ii) at least one structured data storage for storing vendor information and accounts payable information in communication with the computing device; wherein the computing device carries out the steps of self-audit for recovering the sales taxes, comprising: a). receiving scope and size of audit from a user; b). retrieving the vendor information and the accounts payable data from said at least one data storage according to the scope and the size of the audit for creating a vendor master data file and an accounts payable data file; c). receiving, from the user, information on required fields in the vendor master data file and the accounts payable data file for generating a cleansed vendor master data file and a cleansed accounts payable data file; d). combining the cleansed vendor master data file and the cleansed account payable data file for generating a combined list, wherein the combined list comprises at least one invoice; e). analyzing tax amounts and at least one invoice amount of each of said at least one invoice in the combined list to determine any error in said each of said at least one invoice for generating an initial exception list; f). providing the initial exception list to the user and receiving input from the user for generating a final exception list; and g). generating from the final exception list a plurality of tax reports for recovering sales taxes.

According to yet another aspect of the present invention, it provides a computer readable medium storing executable computer program instructions which, when executed at a computing device, cause the computing device to perform a process of self-audit for recovering sales taxes, the process comprising the steps of: (i) receiving scope and size of audit from a user; (ii) retrieving vendor information and accounts payable data from at least one data storage according to the scope and the size of the audit for creating a vendor master data file and an accounts payable data file; (iii) receiving, from the user, information on required fields in the vendor master data file and the accounts payable data file for generating a cleansed vendor master data file and a cleansed accounts payable data file; (iv) combining the cleansed vendor master data file and the cleansed account payable data file for generating a combined list, wherein the combined list comprises at least one invoice; (v) analyzing tax amounts and at least one invoice amount of each of said at least one invoice in the combined list to determine any error in said each of said at least one invoice for generating an initial exception list; (vi) providing the initial exception list to the user and receiving input from the user for generating a final exception list; and (vii) generating from the final exception list a plurality of tax reports for recovering sales taxes.

### BRIEF DESCRIPTION OF THE DRAWINGS

The invention will now be described in more detail with reference to the accompanying drawings, in which:

FIG. 1 is a flowchart depicting the general system overview of a preferred embodiment of the present invention;

FIG. 2 is a flowchart depicting the databases required and the necessary fields therein;

FIG. 3 is a flowchart depicting the data parameters as specified by a user;

FIG. 4 is a flowchart depicting the integration of the data files with the external tax instructions to prepare an exception list;

FIG. 5 is a flowchart depicting requirements to be made by the user in determining a mode to organize the exception invoice list; also to prepare a spreadsheet file of invoices;

FIG. 6 is a flowchart depicting the activities process the claimant-user utilizes in order to realize the sales tax recoveries;

FIG. 7 illustrates a data structure after data manipulation, which is used as a basis for tax differential identification;

FIG. 8 is a collection of the algorithmic tables detailed used to reflect the various potential for tax amount differentials from that originally posted to the accounting records by the company user; and

FIG. 9 shows a list of fields defined for a recovery claim list format of the present invention.

### DETAILED DESCRIPTION OF THE INVENTION

The following paragraphs will describe the present invention by reference to the attached design flowchart illustrations of methods, procedures and systems as well as examples and typical situations where sales tax differentials can be identified by the present invention. Throughout this description, the design flowchart and example shown should be considered as exemplars, rather than limitations on the present invention.

It should be noted by one of ordinary skill in the art, that the present invention may be embodied as a method, a data processing system, or a computer program product.

It should also be noted that the present invention might take the form of a computer program product on a computer-readable storage medium having computer-readable programme code means within the storage medium. Conventional and appropriate computer readable storage medium may be utilized by the company employee user including but not limited to hard disks, CD-ROM, optical storage devices or magnetic storage devices. It is vital when understanding the various flowchart illustrations described above, that the tax recovery method contained herein may be loaded onto and used with at least one general-purpose office computer or alike for carrying out the steps of the tax recovery method.

The present invention flowcharts describe a method and system procedure that are instructional in nature for the benefit of its user, who would not in the normal course of daily activities employ such step-by-step instructions to achieve the tax recovery outcome results. The resultant outcome will be useful in assisting the user in adhering to jurisdictional tax compliance requirements. To the user, the method is to manipulate the accounts payable transactional accounting data, with the unexpected result indicating a deviation or differential tax entitlement from what the user had originally identified in the normal company tax accounting process.

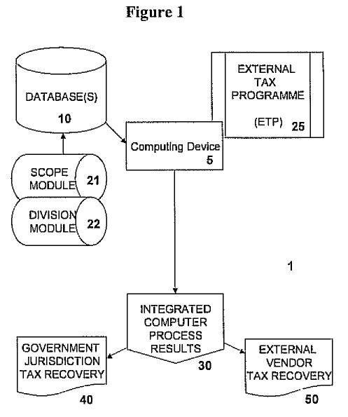

FIG. 1 illustrates a flow chart depicting the general overview of a preferred embodiment of the present invention. The system 1 comprises at least one computing device 5, such as a personal or office computer accessible to an authorized user (not shown), and at least one structured data storage 10, i.e. database, accessible internally or remotely from the computing device 5, where the structured data storage 10 containing various information regarding business activities including accounting related information. The computing device 5 is capable of carrying out the process steps defined in External Tax Programme (or ETP) 25. The system 1 further comprises a scope module 21 for defining and limiting the scope of an audit, and a division module 22 for dividing the scope of the audit into manageably sized data segments. Both the scope module 21 and division module 22 are either internally processed in the computing device 5 or processed externally on another computing device (not shown), and are in communication with ETP 25. The scope module 21 retrieves from the database 10 data according to scope parameters provisioned by the authorized user, then the division module 22 divides the retrieved data into manageably sized segments and presents them to the authorized user via the computing device 5. ETP 25, then, processes each segment of the divided data to identify, by way of exception, sales taxes that have been under claimed or overpaid to government jurisdictions or external vendors, and produces the computational results 30. ETP 25 also provides to the user step-by-step instructions and guidelines for what information to enter and how to determine relevant parameters for identifying exceptions in compliance with tax requirements. ETP 25 further divides the results 30 into two recovery schemes, one is for government jurisdiction tax recovery 40 and the other is for external vendor tax recovery 50.

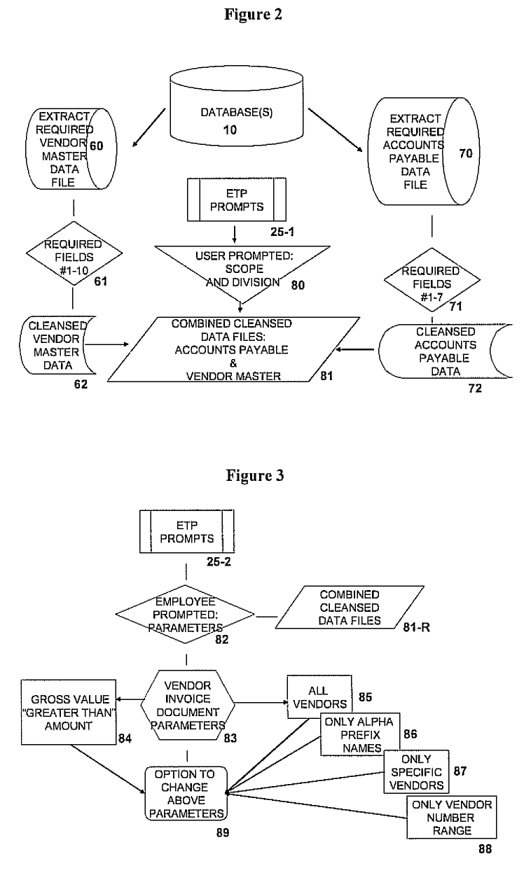

FIGS. 2 to 6 show a process flow diagram of the tax recovery method of the preferred embodiment of the present invention. Referring to FIG. 2, the system 1 retrieves data from the database 10 for creating a vendor master data (or vendor master data file) 60 and an accounts payable data (or accounts payable file) 70. Once data is retrieved and generates the vendor master data file 60, ETP 25 processes the extracted data to make sure that all necessary fields regarding all the vendors are extracted properly (no missing data or errors in data) at step 61. ETP 25 further prompts the user for entering missing data or correcting errors that may be discovered during processing at step 62. In parallel or in sequence before or after ETP 25 processes the vendor master data file 60, ETP 25 further processes the accounts payable data file 70 to make sure and identify any errors or missing data in the file 70 at step 71. Once ETP 25 identifies the errors/missing data, ETP 25 prompts the user to correct or add data accordingly at step 72.

FIG. 7 illustrates the list of fields required for creating the vendor master data file 60 and the accounts payable data file 70, including, but not limited to, vendor number 201, vendor name 202, invoice number 203, invoice date 204, invoice amount 205, cheque number 206, cheque date 207, tax 1 amount (i.e. GST in Canada) 208, tax 2 amount (i.e. HST in Canada) 209, tax 3 amount (i.e. QST in Quebec, Canada) 210, tax 4 amount (i.e. other Provincial tax) 211, and item description code (or item category pursuant to tax law) 212. In the preferred embodiment of the present invention, invoice amount 205 comprises gross invoice amount, net invoice amount or both gross and net invoice amounts.

Referring back to FIG. 2, while, before or after ETP 25 processes the vendor master data file 60 and the accounts payable data file 70, ETP 25 provides the user at step 25-1 for receiving provisional data for setting up parameters for the scope module 21, and divisional size parameter for the division module 22 at step 80. The user chooses the scope of the audit in terms of time period (monthly, annual or multi-year) for the scope module 21. Scope size may often be depending on the size and magnitude of the database 10, thus ETP 25 may suggest to segment the audit into workable segments by division, divided by the division module 22. These parameters for scope and division may be applied to retrieve data from the database 10 to construct the vendor master data file 60 and the accounts payable data file 70, or after (or while) ETP 25 processed (or is processing) both the vendor master data file 60 and the accounts payable data file 70. In either way, the vendor master data file 60 or the accounts payable data file 70 contains scoped, divided and corrected data (or cleansed) for the internal audit ready to be processed. Then, ETP 25 combines the cleansed vendor master data 62 and cleansed accounts payable data 72 at step 81.

Referring to FIG. 3, ETP 25 prompts the user at step 25-2 and receives from the user a set of parameters for processing combined data file (combined list) 81-R, which is resulted from the step 81 in FIG. 2, at step 82, comprising at least one invoice. For example, the user is prompted to choose how much of the data transactions need to be audited by specifying one or more specific analysis. Depending on the volume and individual amounts of the individual transaction invoice, the user may specify minimum amount thresholds for the specific analysis. For example, the user may specify minimum $300.00 as the threshold to indicate that only invoices with the value of invoice amounts 205 GREATER than $300.00 will be analyzed for identifying tax saving opportunities. All invoices with less than this amount will be excluded (or ignored) from the analysis. Likewise, the user may elect to analyze invoices from specific vendor(s) specified by alpha prefixes, vendor number range or name(s), or rather may extend the analysis to invoices from all the vendors. In such either case, ETP 25 receives such parameters at step 82.

After the user specifies the parameters at step 82, ETP 25 extracts vendor invoice document parameters at 83 and generates reports on gross, net or both gross and net total invoice amount(s) of the invoices which are above the minimum invoice threshold amount at step 84, and/or gross, net or both gross and net total invoice amount(s) for all vendors 85, gross, net or both gross and net total invoice amount(s) for vendors specified by alpha prefix range(s) 86, gross, net or both gross and net total invoice amount(s) only for a specific vendor(s) 87, and/or gross, net or both gross and net total invoice amount(s) for vendors specified by vendor number range(s) 88. These results are reported to the user for review, and ETP 25 provides an opportunity to revise, multiple times if necessary, parameters at 89 for the user's desirable audit amount.

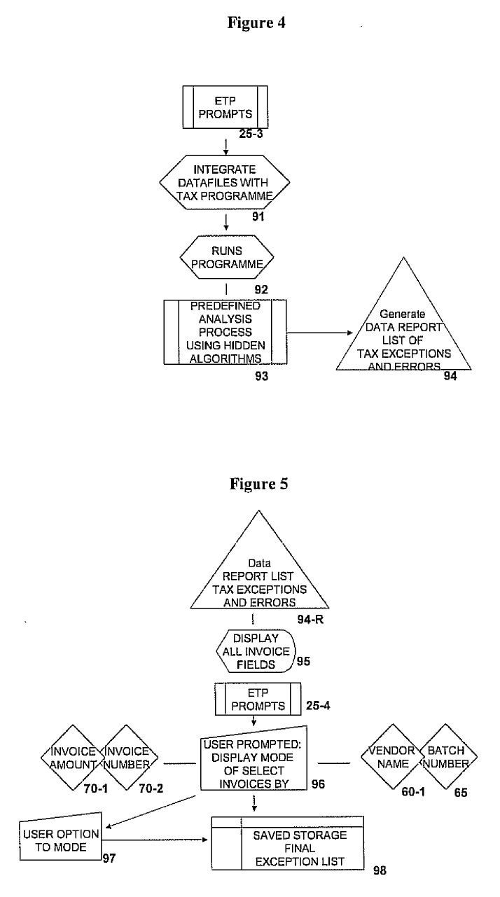

Referring to FIG. 4, ETP 25 prompts the user at step 25-3, and uploads the specified range/segment of the cleansed data to ETP 25 for further process at step 91. Once the data is uploaded to ETP 25, the user is prompted by ETS 25 to execute analysis at step 92, ETS 25 carries out the specified/selected analysis at 93. After ETS 25 runs the analysis, ETS 25 listed up any errors identified from the analysis for further review of the invoices as a data report at step 94.

For further reviewing the invoices, ETP 25 takes into account that the various governmental jurisdictions have different tax rates, rules and regulations, thus the process of analyzing the invoices reflect such differences. For example, there are differences in provincial tax rates in Canada, and some taxes are exempted for paying at the time of the purchase if the items are materials for manufacturing products or for resale. The result being step 94 generates an initial invoice listing automatically of exceptions and errors which includes all previous data fields as specified in FIG. 7. The user need not be concerned with territorial locations of vendors on the list as the internal algorithms are inherently programmed to identify rates and jurisdictions. ETP 25 examines the territorial locations of the vendors by retrieving from the vendor master data file 60, based on vendor name 202 and/or vendor number 203, corresponding tax rates and jurisdictions. ETP 25 determines whether there is any error on paying (or not paying) proper tax amount at a proper rate(s). If there is a discrepancy between analyzed result by ETS 25 and gross, net or both gross and net invoice amount(s) as per data in step 81, this invoice will be marked as the data that has a potential error(s), and will be listed in the initial exception list 94-R, which is resulted from the step 94 of FIG. 4.

ETS 25 also analyzes percentage(s) of tax(es) based on the invoice amount 205 and tax 1 208, tax 2 209, tax 3 amount 210 and tax 4 amount 211. ETS 25 maintains expected gross tax rates, and compares these with the calculated percentages. If there is any discrepancy, the invoice will be marked as the data that has a potential error(s), and will be listed in the initial exception list 94-R. The initial exception list 94-R provides for the user a plurality of separate error codes, at least four in the preferred embodiment of the present invention, which denote the type of tax error identified as either tax1, tax2, tax3 and/or tax4 amounts. Optionally, such percentage may be calculated based on net invoice amount. Referring to FIG. 5, the initial exception list 94-R that contains all invoices that ETP 25 identified as containing error(s) 94 is displayed to the user at step 95, all the fields of these invoices are available for viewing by the user for further inspection. ETP 25 prompts the user at step 25-4 to choose display mode parameters for reviewing these invoices on the initial exception list 94-R at step 96. The invoices on the initial exception list 94-R can be sorted by invoice amount 70-1, invoice number 70-2, vendor name 60-1, or/and batch number 65. The user reviews and confirms the error/exceptions at step 97 for producing a final exception list, and at step 98, once the user satisfies with the exception list, the exception list is saved in a structured data storage, i.e. database 10, table(s), spread sheet(s), or any other structured data storage. ETP 25 organizes the invoices into such a format according to the display mode parameters so the user may conveniently and as a conclusive event, retrieve and review the invoices and their supporting documentation from their archives (hard copies or soft copies in electronic forms). The user has further option of selective viewing of the invoices in the list 94-R, i.e. ETP 25 displays the list 94-R, and beside each invoice, there is a check box for the user to select whether the user is interested in investigating further. This feature permits the user to quickly glance through the initial exception list 94-R and filter out all unessential invoices prior to the further review. Prior to finalizing the exception list 94-R, ETP 25 prompts the user once again an opportunity to review, change or revise display modes and the exception list 94-R. Then, the user once satisfied with the list, ETP 25 generates the final exception list 98-R.

ETP 25 periodically, and/or when necessary, initiates and updates tax rate automatically via a communication network from an external central server or via a computer readable storage means, such as a CD, DVD or alike, to ensure the analysis are relevant to the respective government jurisdictions and time periods. The updates are selectively used by ETP 25, depending on the invoice date as specified in the accounts payable transactions in the database 10. The information in the updates is preferably stored in at least one structured data storage, i.e. database.

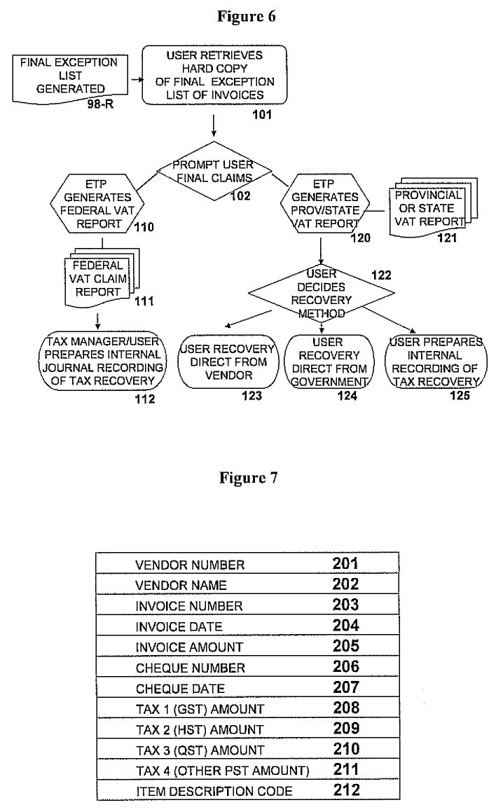

Referring to FIG. 6, once the final exception list 98-R is generated by the ETP 25 at step 98 in FIG. 5, the user retrieves the necessary invoices and supporting documentation for each listed claim in the final exception list 98-R at step 101. This step 101 may involve a step of retrieving soft scanned copies of such invoices/documentations from the database 10, or retrieving actual hard copies from the archive/file storage (not shown).

After retrieving the necessary information, ETP 25 prompts the user to decide as to which invoices with the tax differentials will be entered as official claims at step 102 by showing different scenarios and tax savings to opt the savings. ETP 25 provides predetermined claim list format 300 for entering/collecting the necessary content, including, but not limited to, Vendor Number 301, Vendor Name 302, Invoice Number 303, Invoice Amount (gross, net or both gross and net) 304, Tax 1 (or GST) Amount 305, Tax 2 (or HST) Amount 306, Tax 3 (or QST) Amount 307, Tax 4 (other Provincial) 308, Item Description (or Item Category) 311, and Registration Number for GST/HST/QST 312, referring to FIG. 9. The claim list, conforming the claim list format 300, will be submitted to government jurisdiction, vendor, or retained for government auditor upon inspection during future audit.

The claim summary lists must be segregated between VAT federal responsible claims, VAT provincial/state governmental claims or VAT claimed directly from the vendor. Thus, ETP 25 instructs the user to decide the final claim at step 102. ETP 25 instructs the user to extract information from the database 10 subject to the prescribed claim fields. When completed, ETP 25 generates each claim summary list in compliance with tax authority requirements as specified by law.

If the user selects VAT federal responsible claims, then ETP 25 instructs the user what method of recovery should be followed in each of the above claim summaries at step 110, and generates the VAT federal responsible claim report at step 111. Likewise, if the user decides VAT provincial/state government claims (or VAT claimed directly from the vendor), then ETP 25 instructs the user what method of recovery should be followed accordingly at step 120, and generates the VAT provincial/state government claims at step 121. Optionally, the user may need to prepare an accounting journal entry recording the VAT recovery in the internal company books of account. This entry will flow automatically in the general accounting system to be accumulated with all the other normal federal tax entitlements when filed with the government authorities at step 112. For provincial/state and vendor direct claim documents, they are forwarded to the appropriate party as instructed in ETP 25 at step 122. The vendor master data file 60 is used to allow the user to obtain contact information on direct vendor claim enquiries conveniently and accurately.

Advantageously, the user has the benefit of control over the speed, timing, execution and quality of the self-audit invention process due to the step-by-step logically organized process this invention provides. ETP 25 enforces the user to analyze claim recovery process into a predetermined direction by not allowing the user to deviate from the process for the expressed purpose of securing supportable recovery claims to be achieved. In addition, ETP 25 further offers the user an advanced tool in terms of data management and administration of the accounting data.

The user has another advantage of issuing internet e-mails of the claims directly to the vendor by transmitting claim information through company's server and transmitting scanned documentation to vendors in a timely manner.

The reports generated via the invention indicate a level of tax compliance and identify areas of non-compliance transactions as well. The advantages of the invention are that it maximizes tax entitlements and eliminates tax overpayments to vendors and government jurisdictions.

In addition, each and every invoice vendor transaction is analyzed on its own merit, to identify differentials from what was originally recorded as claimed in the accounting journals. The analysis identifies favourable regulatory exemptions on a provincial/state level and includes, but is not limited to, a) reducing tax liability, b) eliminating incorrect payments on exempt transactions, c) providing the ability to reduce exposure from tax liability, and d) potentially mitigates any penalty and interest on sales tax government audits in the future.

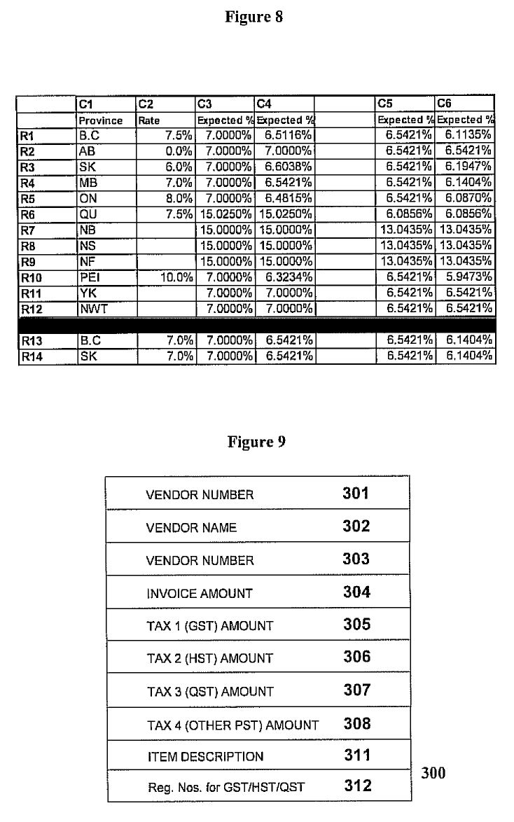

FIG. 8 illustrates a number of the key “percentage indicators” for detecting errors or exception from the invoices in the case of Canadian Tax system calculated during step 93 of FIG. 4. Various percentage numbers in columns C3, C4, C5 and C6 are used by ETP 25 based on the analysis and amount available on the invoice. C3 is the expected percentage of GST/HST when the amount of GST/HST is divided by the net invoice amount; C4 is the expected percentage of GST/HST when the amount of GST/HST is divided by the sum of net invoice amount and PST (other tax); C5 is the expected percentage of GST/HST when the amount of GST/HST is divided by gross invoice amount (or sum of net invoice amount plus the amount of GST/HST); and, C6 is the expected percentage of GST/HST when the amount of GST/HST is divided by the sum of gross invoice amount and the amount of (other tax) PST (or net invoice amount plus the amount of GST/HST, plus the amount of PST (other tax)). Each of rows R1 to R14 represents each province in Canada. For example, assuming that the invoices under audit is before July 2006, thus GST was still 7.0%. Then, for Ontario as shown in row RS, then C3 is 7.00%, C4 is 6.4815%, C5 is 6.5421% and C6 is 6.0870%.

Missed GST:

ETP 25 makes multiple passes over the combined cleansed data set 89-R (generated after step 89 of FIG. 3), each time ETP 25 passing through, generating and gathering comparative tables. In the data sets 89-R, one invoice number may appear several times depending on the invoice distribution. For example, ETP 25 provides a “Vendor Summary” test, in which ETP 25 sums all invoices in the combined cleansed data set 89-R, where the Vendor Number and the Invoice Number are the same. It also sums the GST claimed on each invoice. The next step is to total all of the invoices and all of the GST and test the percent. A perfect 7% (or 6% for invoices after July 2006) would indicate all GST have been recorded properly on this vendor. At the same time ETP 25 counts the number of invoices where the invoice amount is positive but the GST amount is zero. For example, if there are one hundred invoices and ninety-eight of them have GST and two do not—these TWO would make the exception list. Furthering this example, conversely if 50 of the invoices lacked GST there is likely a logical explanation and this result would NOT make the exception list.

Missed QST:

QST is calculated on the base amount of the invoice plus the GST. So assuming QST is 7.5%, then QST is equal to 8.025% (assuming GST is 7%) of the invoice NET amount. ETP 25 would recalculate the NET invoice amount by taking the GROSS amount less any amounts in the GST and QST fields. The GST percent is then calculated on this newly recalculated NET amount. If correct the percent will equal 7%. If, however, there was QST that was missed (and therefore would not have been deducted in recalculating the NET) the percentage calculated for GST would equal 6.4799%. For example, assume that the invoice NET amount is 100, then GST of 7% (7/100) on the invoice NET amount becomes 6.4799% (7/108.025) when compared to the newly recalculated NET invoice amount (the invoice NET amount (or 100) plus QST (or 8.025)). Any invoice(s) that does not meet this criterion will be made into the exception list. This exception list would then be compared to the cost centre, store or plant location. If any of these are in the province of Quebec, the exception list would be of a very high quality.

Tax Paid in Error PST:

There are many complicated issues with Provincial Sales Taxes (PST). The first step is to determine if PST was in fact paid. Since it is a non-refundable tax it is not isolated in the accounting system. However using percentages, ETP 25 can determine if there was PST on the invoice. By redefining the NET invoice as GROSS less GST, HST & QST, and then by calculating the GST percentage, ETP 25 can point to particular invoices where PST was paid. For example, if the percentage of PST over the NET invoice amount plus GST is at 6.4815%, then this indicates Ontario Provincial taxes have been charged on the invoice. In this example, an Ontario reseller (merchant) should not pay PST on goods for resale. ETP 25 then compares invoices with this percentage to the G/L account charged looking for instances where a 6.4815% invoice has been charged to the INVENTORY G/L account. An exception report is generated and refund claims should be processed.

ETP 25 further identify other various types of errors and exceptions. For example, in the case if keying the GST the amount is off by one decimal i.e. 1070.00 GST is entered as 7 rather than 70, then any of the expected percentages listed in FIG. 8 would not match. ETP 25 access the differences in the expected percentage and actual to conclude that there is error entering the net invoice amount, GST and PST entered and actual ones.

Another common error is where QST was not entered. GST amount on the gross invoice amount would not be affected; however, the calculation on the net invoice amount will skew, thus EST 25 is able to identify Such error. EST 25 would also be able to identify yet another common error, that is where QST is mistakenly entered as the GST and the GST was not entered, or in a case where the vendor mistakenly did not charge PST, in a similar manner.

Forgoing shows data entry errors and how ETP 25 identifies such errors. The following is for detection of the system generated error, i.e. system generated Input Tax Credit error, whereby an internal accounting system calculates the GST based on a purchase order (or P.O.) tax status, $100 example.

It is to be understood that the embodiments and variations shown and described herein are merely illustrations of the principles of this invention and that various modifications may be implemented by those skilled in the art without departing from the spirit and scope of the invention.

What is claimed is:

1. A computerized method of self-auditing for recovering sales taxes, comprising the steps of:
(i) receiving scope and size of audit from a user;
(ii) retrieving vendor information and accounts payable data from at least one data storage according to said scope and said size of said audit for creating a vendor master data file and an accounts payable data file;
(iii) receiving, from said user, information on required fields in said vendor master data file and said accounts payable data file for generating a cleansed vendor master data file and a cleansed accounts payable data file;
(iv) combining said cleansed vendor master data file and said cleansed account payable data file for generating a combined list, wherein said combined list comprises at least one invoice;
(v) analyzing tax amounts and at least one invoice amount of each of said at least one invoice in said combined list to determine any error in said each of said at least one invoice for generating an initial exception list;
(vi) providing said initial exception list to said user and receiving input from said user for generating a final exception list; and
(vii) generating from said final exception list a plurality of tax reports for recovering sales taxes.

2. The method as recited in claim 1, wherein said step (v) further comprises the sub-steps of:
(i) calculating at least one expected tax rate for each of said tax amounts;
(ii) calculating at least one actual tax rate, corresponds to said at least one expected tax rate, for each of said tax amounts; and
(iii) comparing said at least one expected tax rate with said at least one actual tax rate for each of said tax amounts and determining whether said tax amount is correct, missed, being overpaid, or underpaid.

3. The method as recited in claim 1, wherein said at least one invoice amount in said step (v) comprises gross invoice amount.

4. The method as recited in claim 1, wherein said at least one invoice amount in said step (v) comprises net invoice amount.

5. The method as recited in claim 1, wherein said required fields in said step (iii) comprises vendor number, vendor name, invoice number, invoice date, invoice amount, cheque number, cheque date, at least one sales tax amount, and at least one item description code.

6. The method as recited in claim 5, wherein said invoice amount comprises gross invoice amount.

7. The method as recited in claim 5, wherein said invoice amount comprises net invoice amount.

8. The method as recited in claim 1, wherein said plurality of tax reports in said step (vii) comprises at least a federal sales tax claim report and a regional sales tax report.

9. The method as recited in claim 1, wherein said at least one data storage in said step (ii) is at least one database.

10. A self-audit system for recovering sales taxes, comprising:
(i) a computing device; and
(ii) at least one structured data storage for storing vendor information and accounts payable information in communication with said computing device;
wherein said computing device carries out the steps of self-audit for recovering said sales taxes, comprising:
a. receiving scope and size of audit from a user;
b. retrieving said vendor information and said accounts payable data from said at least one data storage according to said scope and said size of said audit for creating a vendor master data file and an accounts payable data file;
c. receiving, from said user, information on required fields in said vendor master data file and said accounts payable data file for generating a cleansed vendor master data file and a cleansed accounts payable data file;
d. combining said cleansed vendor master data file and said cleansed account payable data file for generating a combined list, wherein said combined list comprises at least one invoice;
e. analyzing tax amounts and at least one invoice amount of each of said at least one invoice in said combined list to determine any error in said each of said at least one invoice for generating an initial exception list;
f. providing said initial exception list to said user and receiving input from said user for generating a final exception list; and
g. generating from said final exception list a plurality of tax reports for recovering sales taxes.

11. The system as recited in claim 10, wherein said step e. further comprises the sub-steps of:
(i) calculating at least one expected tax rate for each of said tax amounts;
(ii) calculating at least one actual tax rate, corresponds to said at least one expected tax rate, for each of said tax amounts; and
(iii) comparing said at least one expected tax rate with said at least one actual tax rate for each of said tax amounts and determining whether said tax amount is correct, missed, being overpaid, or underpaid.

12. The system as recited in claim 10, wherein said at least one invoice amount in said step e comprises gross invoice amount.

13. The system as recited in claim 10, wherein said at least one invoice amount in said step e comprises net invoice amount.

14. The system as recited in claim 10, wherein said required fields in said step c. comprises vendor number, vendor name, invoice number, invoice date, invoice amount, cheque number, cheque date, at least one sales tax amount, and at least one item description code.

15. The system as recited in claim 14, wherein said invoice amount comprises gross invoice amount.

16. The system as recited in claim 14, wherein said invoice amount comprises net invoice amount.

17. The system as recited in claim 10, wherein said plurality of tax reports in said step g. comprises at least a federal sales tax claim report and a regional sales tax report.

18. The system as recited in claim 10, wherein said at least one data storage in said step b. is at least one database.

19. A computer readable medium storing executable computer program instructions which, when executed at a computing device, cause said computing device to perform a process of self-audit for recovering sales taxes, the process comprising the steps of
(i) receiving scope and size of audit from a user;
(ii) retrieving vendor information and accounts payable data from at least one data storage according to said scope and said size of said audit for creating a vendor master data file and an accounts payable data file;
(iii) receiving, from said user, information on required fields in said vendor master data file and said accounts payable data file for generating a cleansed vendor master data file and a cleansed accounts payable data file;
(iv) combining said cleansed vendor master data file and said cleansed account payable data file for generating a combined list, wherein said combined list comprises at least one invoice;
(v) analyzing tax amounts and at least one invoice amount of each of said at least one invoice in said combined list to determine any error in said each of said at least one invoice for generating an initial exception list;
(vi) providing said initial exception list to said user and receiving input from said user for generating a final exception list; and
(vii) generating from said final exception list a plurality of tax reports for recovering sales taxes.

20. The computer readable medium as recited in claim 19, wherein said step (v) further comprises the sub-steps of:
(i) calculating at least one expected tax rate for each of said tax amounts;
(ii) calculating at least one actual tax rate, corresponds to said at least one expected tax rate, for each of said tax amounts; and
(iii) comparing said at least one expected tax rate with said at least one actual tax rate for each of said tax amounts and determining whether said tax amount is correct, missed, being overpaid, or underpaid.

21. The computer readable medium as recited in claim 19, wherein said at least one invoice amount in said step (v) comprises gross invoice amount.

22. The computer readable medium as recited in claim 19, wherein said at least one invoice amount in said step (v) comprises net invoice amount.

23. The computer readable medium as recited in claim 19, wherein said required fields in said step (iii) comprises vendor number, vendor name, invoice number, invoice date, invoice amount, cheque number, cheque date, at least one sales tax amount, and at least one item description code.

24. The computer readable medium as recited in claim 23, wherein said invoice amount comprises gross invoice amount.

25. The computer readable medium as recited in claim 23, wherein said invoice amount comprises net invoice amount.

26. The computer readable medium as recited in claim 19, wherein said plurality of tax reports in said step (vii) comprises at least a federal sales tax claim report and a regional sales tax report.

27. The computer readable medium as recited in claim 19, wherein said at least one data storage in said step (ii) is at least one database.
